(19) United States
(12) Patent Application Publication
(10) Pub. No.: US 2006/0130002 A1
(43) Pub. Date: Jun. 15, 2006

(54) Requirement defining method, method for developing software, and method for changing requirement word, and newly defining method

(76) Inventors: Sadahiro Hirayama, Tokyo (JP); Fumio Negoro, Kanagawa (JP)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(21) Appl. No.: 10/526,803

(22) PCT Filed: Sep. 9, 2003
(86) PCT No.: PCT/JP03/11486

§ 371 Date: Nov. 8, 2005

(30) Foreign Application Priority Data
Sep. 9, 2002 (JP) 2002-262670
Jan. 17, 2003 (JP) 2003-10454

(51) Int. Cl. G06F 9/44

(52) U.S. Cl. 717/131

(57) ABSTRACT

An output items to be finally obtained by computer software which is a development object are determinded, these items are prescribed using a data generation equation using interim data items, and all the interim data items are prescribed by separate data generation equations. This is continued until all new data items are prescribed by input data, and prescriptions of the data items, data generation equation, and data generation execution condition and the like obtained as the result constitute requirement definition. Furthermore, the requirement definition obtained in this manner is applied to a method of automatically finding a process order of data items based on the definition, or automatically establishing data in a correct order to automatically develop a program, and accordingly the software to be finally obtained is automatically developed. To change a requirement word group completed as requirement definition, other words that define a generation method of the word concerned before and after the change, and other words whose generation method is defined by the word concerned among the other words, and the definition for such words are extracted and provided, and necessity of the change for them is studied. If “necessary”, the change is performed and continued. If “not necessary”, the influence is interrupted there, and therefore the change of the word concerned ends. A problem that a range of the influence of the change is not limitable in a conventional method is solved.

### TECHNICAL FIELD

The present invention relates to a software developing method, particularly to a requirement defining method by a chain type data item prescribing method, an automatic developing method of computer software, a changing method of a requirement word concerning a requirement defining method by a chain type data item prescribing method, and a newly prescribing method of a requirement word.

### BACKGROUND ART

According to a conventional software developing method, basically all programs are prepared only by a combination of three types of basic imperative sentences of (1) order process, (2) selection branching process, and (3) repetition process. Here, (1) order process refers to a process to execute data processing in order of described program sentences, (2) selection branching process refers to a process to judge conditions and branch an execution order of data processing from the order of the described program sentences to another program sentence, and (3) refers to a process to repeatedly execute the described program sentence while a certain condition is established.

These imperative sentences all indicate the process order, and a person has to indicate all the process orders of data items with respect to all the programs by these sentences. In a complicated business system in which there are many data items or execution conditions are complicated and diversified, to indicate a correct process order by programming, the person has to understand the business system well, and correctly grasp the process order of all the data items. In this respect, even when the process order of only some data items is partially grasped, as a relation of all data has to be determined, such partial process order grasping has no meaning.

Setting the programming in this correct process order as a final purpose, business analysis, business design, system design, program design and the like are performed as preparatory operations for this purpose, and the operations are variously devised, for example, as follows.
A data flow diagram is prepared as a diagram showing a flow of data in a business system.
A function group (function of calculating, e.g., individual sales amount and further totaling such amounts) having data processing functions including several element functions (e.g., a function of calculating the sales amount as “unit price×quantity”) of data processing is prepared in a correct process order (referred to as “module”), and further the modules are combined in the correct order to thereby prepare a whole program.
A flowchart showing an order of data processing is prepared.
Interim data items are prepared during the data processing to sort out ideas.
An interim file is prepared during the data processing to limit a range to think about.

In a conventional developing method of software, as seen from a business system side, individual element functions (e.g., the function of calculating the sales amount as “unit price×quantity”) of the business system are first determined, next an execution order of such functions is determined, and finally these functions are instructed to the computer by the program. As described above, since the computer cannot search the processing order by itself, the person has to instruct all of processing orders. Since a business element function is determined by a business division that is a software user, the function is referred to as a user's logic, and the execution order of the data processing is referred to as a control logic.

In brief, the conventional programming means that a given user's logic and a correct control logic are instructed to the computer. Individual user's logics have to be necessarily determined by a user, and can be comparatively easily determined. A reason why an programming work becomes complex and enormous is that it is not easy to correctly indicate the control logic. As the preparations or devices for this enormous and complex work, the above-described detailed business analysis, business design, preparation of the data flow diagram, program design, preparation of the module, preparation of the flowchart, setting of the interim data item, setting of the interim file and the like are performed. They are all preparatory operations for writing the program in the correct order. After such operations, the control logic of the correct process order is indicated by the programming.

To summarize the above description, the data processing order has heretofore been instructed to the computer by human beings by the program, but in the complicated system, it is not easy for the human beings to instruct the process order of all the data items to the computer without any mistake. Therefore, the flow of all the data of the whole system has to be correctly understood/grasped, and the preparations before the programming, including the business analysis, business design, preparation of the data flow diagram, program design and the like, or the enormous programming operations are required. Therefore, costs and time also become enormous in the present situation.

The above-described problem will be studied in more detail.

In the conventional software developing method, since the computer cannot find the process order of the data items by itself as described above, the human beings have to instruct all of them, but even in a slightly complicated system, the process orders become complicated, and it is not easy to understand/grasp all of them. This causes the following problems.
Enormous work, time, and cost are required for development of software.
Since a certain degree of system engineering knowledge is required for an end user to design the business system, eventually there is a tendency to depend excessively on a system engineer.
The system engineer who does not have business experience and who has no responsibility to manage•/achieve the business tends to take leadership.

In addition to these problems, since the system engineer takes the leadership, the developing and revising programs has to be repeatedly performed over again until the software really demanded by the end user is completed. There has also been a problem that a necessary timing is missed in many cases.

On the other hand, the program needs to be constantly changed. In a newly developed program, there is rather few cases in which all business or program systems are determined from the beginning. Therefore, it is a usual phenomenon that the program has to be changed in a initial programming process. Even with regard to the already completed program, since requirements constantly change in accordance with changes of business environments or management principles, the program needs to be constantly changed in accordance with these changes.

However, it has heretofore been not easy to change even the program which is being newly developed, or the existing programs already completed once. A fundamental cause lies in that the person has to instruct the process order to the computer by the program in the conventional method. Therefore, there has been a problem that the changing of the program in accordance with the changes of the requirements is very laborious, and enormous manpower, cost, and time are eventually required for the changing of the requirements. This situation will be described in more detail.

As described above, in the conventional program method, the data is processed in accordance with the order of the imperative sentences written in the program. Therefore, the process order is instructed or has to be instructed by the order of the imperative sentences the person writes, or by destination of a conditioned branch the person writes. Since the process order is determined in this manner, a value of one data item in a program is determined by preprocessing until such item is processed, and such processing. Therefore, the value of one data item changes in accordance with a place where such item is written in one program. Therefore, when the preprocessing is understood, one data item may have another data generation equation or another value in one program. That is, there is no need that “one data item has the equal one value regardless of the preprocessing in one program.” Consequently, the process order has to be determined by the person. Therefore instead a degree of freedom is generated in definition or value of the data item. Therefore, the place used and definition of one data item in one program are not known by a person other than a person who prepares the program. Even the preparer does not remember the place or the definition for long.

For example, assuming that there are imperative sentences in a part of the program as below:
y=ax+b
y=y+1
y=y+1
y=y+1
then the last y is obtained by adding 3 to first y. That is, y may have different values depending on the place in the process stage. This characteristics of conventional method is after all the same regardless of a type of program language, such as COBOL, C++, and Java (registered trademark).

In this program, it is assumed that y=ax+b is to be changed to y=cz−d from a certain stage of program. In the program, various processing methods are instructed for y in varios places of the program, and such y is hidden in various places of the program. This y has to be correctly changed. However, the followings are troubles.

\textcircled{1} Since a person can write program arbitrarily without any rule, the place of y in the whole program is not seen.

\textcircled{2} How to change the data generation equation of y in certain stage is not known until the preprocessing of y is traced back and understood.

\textcircled{3} Since y may be represented in the form of ax+b, it cannot be said to be sufficient to search only y.

\textcircled{4} When y is changed, another program (e.g., the is data generation equation of x or z) may have to be changed as a repercussion effect.

\textcircled{5} In a change indicating that conditions are added to perform selection branching, another portion of the program has to be changed into the form of conditioned selection branching in accordance with such change. Consequently, it is not easy to find all of the above issues and correctly change them.

After all, a reason why a program change operation is difficult in the conventional method is that another portion to be changed in accordance with the change of one place is not easily seen in enormous imperative sentences in the program. Repeatedly to say, the fundamental causes for these issues are as follows.
The “person” has to instruct the process order (control logic) of the process method (user's logic) of individual business elements in the form of the program in such a manner as to the computer can understand the requirements.
   Therefore, as the program is prepared by arbitrarily setting the process order (control logic) by the “person”, what data item is there, what processing method is for it, and where such item is, is not known in the whole program. Therefore when one place is changed, an influence of the change on the whole program is not automatically known.

The conventional-method program involves the above-described difficulty with regard to the change. Therefore, to correctly change all, the person has to track all the imperative sentences in the program in detail, and extract and change necessary portions to be changed. Needless to say, from the property of the business, it may be judged that the change must not influence such and such different portion of the program, so that detailed review may not be performed, but theoretically it must be recognized that a necessary change could extend to anywhere in the program.

The characteristics of the conventional method concerning the change of the program in accordance with the change of the requirement have been described above. However, the characteristics of the conventional method in newly preparing the program have to be firstly described.

In the conventional method, as described above, the process order of the data items has to be instructed to the computer by the program in detail by the person. However, in the complicated system, it is not easy for the person to instruct the process order of all the data items to the computer by the program without any mistake. To correctly instruct the process order, needless to say, all the data of the whole system and the flow of the data have to be correctly understood and grasped. Therefore, the preparations before the programming, including the business analysis, business design, preparation of the data flow diagram, program design and the like, are required, and enormous programming work are required. Therefore, enormous cost and time are consequently required.

Even if the person does not instruct the process order (control logic) based on the requirements (user's logic), that is, definitions of requirement words following a specific basic rule, and the order is automatically derived, and accordingly the program can be automatically produced, the changing of the program by the change of the requirement can be automatically performed as long as the requirement words are correctly changed. Then, the changing of the program is remarkably facilitated. In this case, one data item in one program has only one value. If not, automatic programming cannot be performed in the first place. A chain type requirement defining method and a method of changing the requirement have exactly such characteristics.

The relation is illustrated in FIG. 3. For detailed description of FIG. 3, the figure is referred to, and the description is omitted.

The present invention is to solve various problems the conventional methods have had, and an object therefore is to provide a requirement defining method capable of automatically defining requirements.

Further object of the present invention is to provide an automatic developing method of computer software by application of the method in which requirements are automatically defined as described above, to the method (e.g., “Lyee (registered trademark)” in which a process order of data items is automatically found based on the requirement definition, or data is automatically established in a correct order.

Here, “Lyee (registered trademark)” refers to invention or methodology relating to a software production or the like invented by Fumio Negoro who is one of inventors of the present invention. Details are described in various international publications prescribed by, for example, International Publication WO97/16784A1 pamphlet (hereinafter referred to also as “Patent Document 1”); International Publication WO98/19232 A1 pamphlet (hereinafter referred to also as “Patent Document 2”); International Publication WO99/49387 A1 pamphlet (hereinafter referred to also as “Patent Document 3”); International Publication WO00/79385 A1 pamphlet (hereinafter referred to also as “Patent Document 4”); International Publication WO02/42904 A1 pamphlet (hereinafter referred to also- as “Patent Document 5”); Jpn. Pat. Appln. laid-open Publication No. 2002-202883 (hereinafter referred to also as “Patent Document 6”).

Moreover, without first defining all requirements and next performing programming as in a conventional method, an object of the present invention is to provide a method of easily and efficiently performing an operation of constructing definition of requirements from the beginning only by definition of individual requirement words, and also a method of changing definition of requirement word in accordance with requirement change to be easily and efficiently performed by a requirement definition method of a chain type data item prescribing method, and further a method of newly prescribing definition of a requirement word to be easily and efficiently performed by the same method.

Moreover, when a newly prescribed requirement word group or a changed requirement word group is applied to a method capable of automatically performing programming regardless of a process order of words, an effect is produced that any person does not have to perform the above-described enormous operation as in a conventional method.

### DISCLOSURE OF THE INVENTION

According to the present invention, to achieve the above-described objects, first problem solving means of the present invention comprises: (a) a step of extracting all output data items to be finally obtained by computer software which is a development object; (b) a step of prescribing each one of the extracted output data items by a data generation equation and a data generation equation execution condition; (c) a step of prescribing all data items by respective data generation equations and data generation equation execution conditions with respect to all the new data items that have appeared in order to prescribe the original data items by the data generation equation and the data generation equation execution condition; (d) a step of repeating the step (c) until the data generation equation is constituted only of an input data item; and (e) a step of executing the steps (a) to (d) with respect to all the output data items to be finally obtained, and also a step of assuming as requirement definition all of the data generation equation and the data generation equation execution condition obtained as a result of the execution of the above steps, and, if applicable, additionally prescription by attribute definition of input/output and explicit indication of a recording medium in which the data item exists.

Further, second problem solving means of the present invention comprises: (a) a step of obtaining requirement definition using the requirement defining method prescribed by the first problem solving means; and (b) a step of applying the definition of data items thus obtained to a method of automatically finding a process order of data items or automatically establishing data in a correct order eventually to automatically develop a program based on data items prescribed in the obtained requirement definition, and obtaining desired software as a result of the application.

A function by the above-described first problem solving means is as follows. That is, by the requirement defining method by the chain data item prescription of the present invention, as long as the data item that is a target is only determined, the requirement can be easily automatically defined starting from the prescription of such data item. In this respect, since the requirement definition by this method does not show the process order of the data items, the definition is not useful in the conventional method.

Further, in the function by the above-described second problem solving means, the method (e.g., “Lyee (registered trademark)”) is used in which after the requirement definition is automatically obtained according to the first problem solving means of the present invention, the process order of the data items is automatically found, or the data is automatically established in a correct order both based on the automatically prepared requirement definition as above, and therfore after all the program is automatically developed. As a result of the eventually completed software, it is possible to automate the software development.

As a result of the usage of the first and second problem solving means of the present invention, human beings do not have to consider the data processing order and instruct such order by the programming to the computer. Therefore, the human beings do not have to perform detailed business analysis, business design, preparation of a data flow diagram, program design, preparation of a module, preparation of a flowchart, setting of interim data items, setting of interim files, further the programming itself, which have been required in the conventional method. Therefore, an enormous software development work which has heretofore been required can be largely reduced. Consequently, development time and cost can be largely reduced. Incidentally, there has heretofore been a concept of a data item group referred to as the list structure in which relation between the individual data item and the other data items constituting the group is represented by a pointer and there has been a programming language based on the concept. On the other hand, the first problem solving means of the present invention relates to a method of extracting the individual data items only by prescriptions of the data items in a chain manner when creating the data item group. There is not any concept of the above-described pointer. The second problem solving means of the present invention relates to a method of application of the data item group prescribed by the first problem solving means (regardless of the list structure and without any pointer) to a method of automatically developing software, in which the process order of the data items is automatically found, or the data is automatically established in the correct order both based on the data item group prescribed by the first problem solving means, thereby the program is automatically developed.

Moreover, in third problem solving means of the present invention, to change the requirement of an automatically prepared program where information with respect to a requirement word (=data item) group prescribed as requirement of software, such as a name of a word, a data generation equation (including obtaining of a value by an input) to obtain a value corresponding to the word, conditions (data generation equation execution conditions) on which the value corresponding to the word is established, attribute definition indicating whether the word is an input or output, and information prescribing a recording medium in which the word exists, are applied to a method capable of performing automatic programming regardless of an order of arrangement of prescribed requirement words, such operations are featured as: (a) an operation of changing (changing including deleting and adding) prescription of the requirement word itself to be changed; (b) an operation of extracting “first link defining words” and “first link containing words” before and after the change of the requirement word of the above (a) having a possibility that prescription change is required by an influence of the change of the prescription of the word of the above (a); (c) an operation of studying whether or not the change of the prescription is required with respect to the individual extracted words of above (b); and (d) an operation of repeating the operations of the above (a) to (c) with respect to the word requiring the change.

Here, the “first link defining words” of a certain word refer to all other words included in the prescription of the word, that is, all the other words required to generate the word.

Moreover, the “first link containing words” of the certain word refer to all the other words including the word in the prescription of such other words, that is, all the other words generated by the word.

Furthermore, in fourth problem solving means of the present invention, to newly develop an automatically prepared program, where information with respect to a requirement word (=data item) group prescribed as requirement of software, such as a name of a word, a data generation equation (including obtaining of a value by an input) to obtain a value corresponding to the word, conditions (data generation equation execution conditions) on which the value corresponding to the word is established, attribute definition indicating whether the word is an input or output, and information prescribing a recording medium in which the word exists, are applied to a method capable of performing automatic programming regardless of an order of arrangement of prescribed requirement words, since both a new requirement prescribing operation and a correcting operation of such prescription are required, new requirement prescription is regarded as a change from nothing in the new development of the program and such operation are featured as: (a) an operation of changing (changing including deleting and adding) prescription of the requirement word itself to be changed; (b) an operation of extracting “first link defining words” and “first link containing words” before and after the change of the requirement word of the above (a) having a possibility that prescription change is required by an influence of the change of the prescription of the word of the above (a); (c) an operation of studying whether or not the change of the prescription is required with respect to the individual extracted words of above (b); and (d) an operation of repeating the operations of the above (a) to (c) with respect to the word requiring the change.

In the present invention of the third or fourth problem solving means as described above, when changing (new development is included and considered here) the program in accordance with the requirement change, the data items to be changed in the program is automatically extracted and changed so that eventually it is possible to correctly change all, whereas all imperative sentences in the program need to be tracked and changed in detail in a conventional method because of its having an allowance for a degree of freedom with respect to definition or value of the data item.

Furthermore, in essence, by appling only information relating to the requirement words prescribed as described above to the method capable of performing automatic programming regardless of the order of the arrangement of the prescribed words (data items), the present invention is also possible to be understood as a program developing method of automatically preparing the program, a method of automatically revising/changing the program, or a method of automatical maintenance for the program.

### BRIEF DESCRIPTION OF THE DRAWINGS

FIG. 1 is a schematic diagram showing a procedure of changing prescription while simultaneously performing a necessary change derived by an influence of one change, when changing (including adding) the prescription of requirement words;

FIG. 2 is a schematic diagram schematically showing a relation between data items, and also schematically showing a data chain requirement definition (DCRD) method; and

FIG. 3 is a schematic diagram showing a conventional technique and the present invention in a comparing manner with respect to a relation between requirement definition and target program.

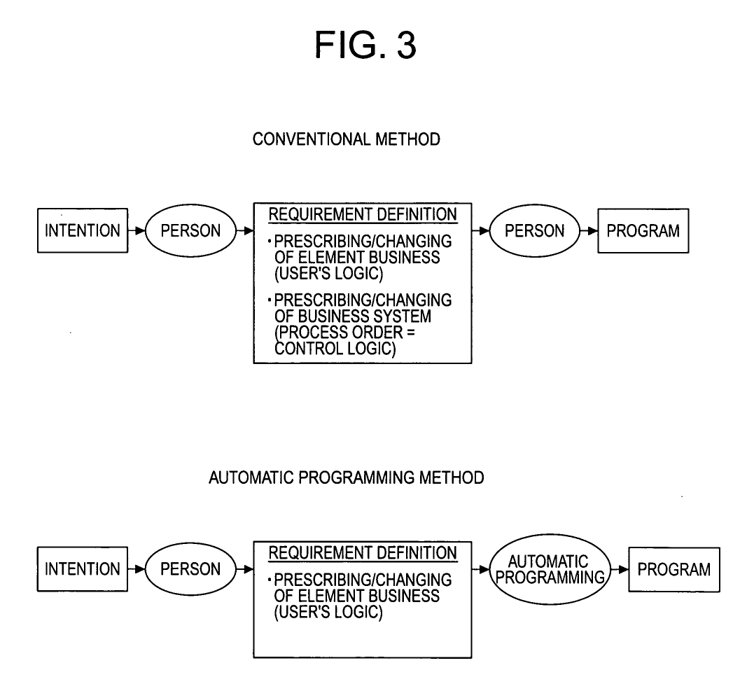

### SUMMARY OF THE INVENTION

A data chain requirement definition method is a method of defining requirement of software only by prescription of a requirement word (=data item) group. As individual requirement words, the followings only may be described:
a name of a word;
a data generation equation (including: obtaining a value by an input) to obtain a value of the word;
a condition (data generation equation execution condition) on which the value of the word is established;
an attribute definition indicating whether the word is an input or output; and
a recording medium in which the word exists.

The data chain requirement definition includes: starting from a data item indicating final intention; first prescribing such data item to derive the final intention; and further prescribing data items newly appearing in the above prescription. This work is repeated to draw necessary data items one after another, and the prescription work is continued until all the drawn data items constitute input data. By this method, all the data items are drawn and prescribed. This is regarded as requirement definition.

In a conventional method, as described in the aforementioned paragraphs of “Background Art”, a person has to instruct a process order of data items one by one to a computer by a program. Therefore, all data and a flow of the data in the whole system have to be correctly understood and grasped. Therefore, preparations such as business analysis, business design, preparation of a data flow diagram, and program design are required before programming, and an enormous program work is required. Therefore, cost and time are enormously required.

On the other hand, in the data chain requirement definition method, the requirement definition is performed by successively prescribing the data items irrelevant to the process order of the data item. Therefore, the above-described laborious preparing operations for first grasping all of the data items from the beginning to determine the process order of all the items in the conventional method are not required, so that in the data chain reruirement definition method the requirement definition can be achieved with very high efficiency.

With regard to the individual data items prescribed in this manner in the data chain requirement definition method, each item is uniquely prescribed in one program with sole meaning, and therefore it is assured that one data item has only one value even when used in any places in one program. This characteristic of the data chain requirement definition method is fundamentally different from the programming of the conventional method. In an example of the aforementioned paragraphs of “Background Art”, separate data items are prescribed in the data chain requirement definition method as follows:
y=ax+b;
y₁=y+1;
y₂=y₁+1;
and
y₃=y₂+1.

Since the order of the data items drawn and prescribed in this manner is completely different from the process order of the data items, this requirement definition is not directly effective in the conventional program development method in which the person has to instruct the process order (control logic). However, when the method (e.g., Lyee (registered trademark). See Patent Documents 1 to 6) which is irrelevant of the process order is used, automatic programming can be performed even by this requirement definition, therefore the data chain requirement definition method is completely effective, and high efficiency of such method is realized as the requirement definition method.

In this method, the changing of the requirement means that the prescriptions of some of the above-described requirement words are changed, and this will be described hereinafter.

To correctly change each of the requirement words, the prescription of each requirement word (e.g., requirement word a) is changed, and additionally a necessary change has to be performed while studying even an influence of the change on the prescription of another requirement word. This is most difficult in the conventional method. The method of requirement change in the data chain requirement definition method will be described with an example as follows.

It is assumed that the requirement word to be changed is a word a. The definition of the word a before the change is assumed as follows:
a=b+c,
   establishing condition: d<100; and
a=e−f
   establishing condition: d>=100.

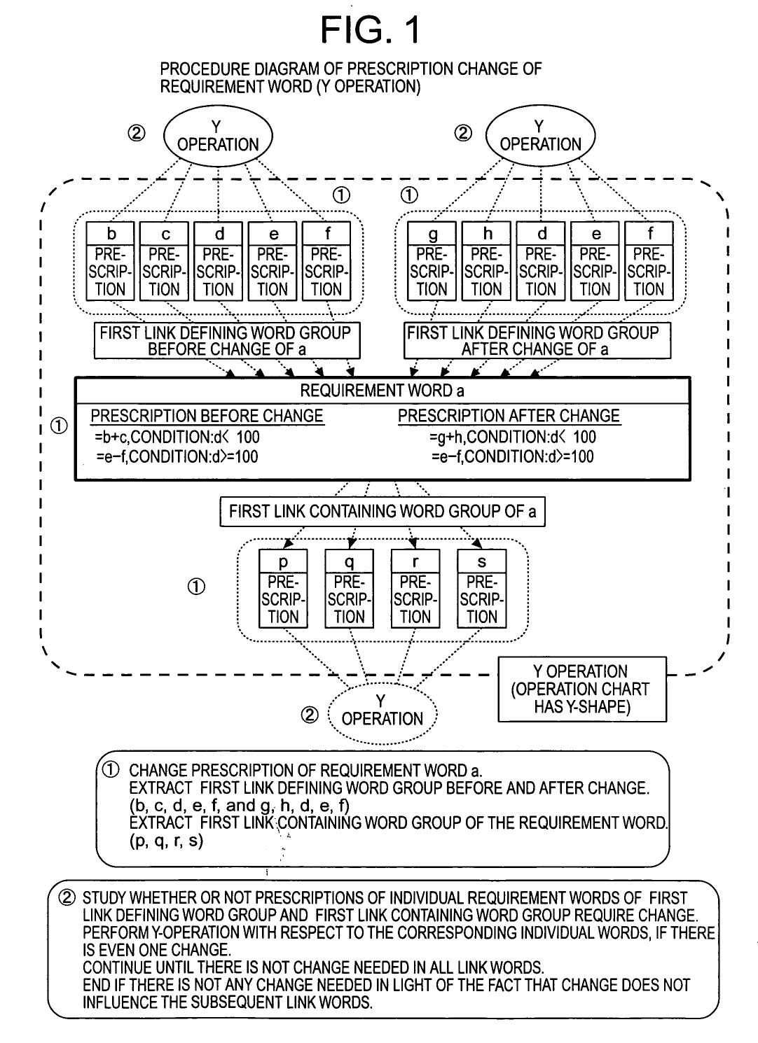

The definition of the word a is first changed, next a word having a possibility of the change by the influence is extracted, and then it is studied whether or not the definition needs to be changed with respect to each word, and the definition is changed if necessary. The procedure is as follows. See FIG. 1 (procedure diagram of prescription change of requirement word).

(a) First, the prescription of the requirement word a itself to be changed is changed (the changing includes deletion/addition).

For example, to change the prescription to a=g+h, or to change the establishing condition, a necessary requirement word prescription or data generation equation execution conditions or other requireement prescription before the change is changed in accordance with the requirement change.

In the deletion of requirement word, the prescrription of the requirement word before the change is changed (deleted).

With regard to the requirement word to be newly added, the word is only newly prescribed without any change of the requirement word before the change.

(b) Next, a first link defining word group (see the following *1) before and after the change of the requirement word a, and a first link containing word group (see the following *2) in the word list are extracted as the requirement words having a possibility that the prescription change is required by the influence of the change of the prescription of the requirement word a of (a).

*1 First link defining words of a certain requirement word a are all other words included in the prescription of the requirement word a, that is, all the other words required for generating the word a. For example, the first link defining words of the requirement word a are the above-described words b, c, d, e, f.

*2 The first link containing words of the certain requirement word a are all other words having prescription including the requirement word a, that is, all other words generated by the word a. For example, the first link containing words of the requirement word a are p, q, r words including a in the following:
p=a*d;
q=g+a; or
r=f/h, establishing condition: a<c.

(c) It is studied whether or not the change of the prescription is required with respect to the individual words extracted in the above (b).

(d) As a result of the above (c), the same operation (Y-operation . . . see FIG. 1) as that of the above (a), (b), (c) is repeated with respect to the word requiring the change.

(e) As a result of the above (d), the change operation of the certain requirement word a is completed, when the change is not required in the prescriptions of all the words derived from the certain requirement word a.

When there is not any change in the certain requirement word a, there is not any change in the first link defining word group or the first link containing word group of the word a, and a propagating change caused by the change of the requirement word a does not have to be performed. Then, the influence of the change is interrupted.

The reason why the influence of the change is interrupted by such word as above is, that since the method of the data chain requirement definition is by nature a method of drawing a new business element (a business element means a requirement word) based on the prescription of one business element, if the business element to be drawn is the same as that before the change so that there is not any change, it is obvious that another business element drawn by the business element that has not been changed is the same as that before the change. If the drawn business element requires the change, this is a new separate change, and is not any repercussion effect. On the other hand, when the certain word a is used in the definition of another word, and there is not any change in the word a, it is also obvious that such other word does not have the change as the repercussion effect of the word a. Therefore, the influence of the change of one requirement word is interrupted by the requirement word in which there is not any change by the influence of the change of one requirement word.

As described above, in the method of changing the requirement in the data chain requirement definition method of the present invention, a range in which the influence of one change extends can be limited, and the requirement word having the possibility of change is provided. This is because all the requirement words are generated in a chain manner, accordingly a word network having mutual consistency is formed, and it is therefore assured that one word has only one value. This is fundamentally different from the change of the program in the conventional method, and is a far superior point. By merging this method with an automatic programming method needing no process order instruction, a dramatic change is brought about in a development/maintenance method of software. A problem of the conventional method that the requirement change and program change are troublesome is fundamentally solved. In the conventional method, as described above, the person has to search a place of a program to be changed in another portion in accordance with a change of one program, and a way to change the program. Since the person arbitrarily performs the programming without any rule, it is very difficult to find such place and way. Theoretically, there is a possibility of change anywhere in the whole program, and therefore the whole program has to be completely searched and considered.

The method of changing the requirement has been described above in the paragraphs of “Summary of the Invention”. When the requirement is newly defined, there is not any requirement word to be changed. However, when the requirement word is newly defined, the change means addition from nothing. Therefore, the method described above in “Summary of the Invention” has been a method of defining a new requirement. Therefore, even in the new prescription of the requirement word, the above-described (a), (b), (c), (d), (e) can be performed.

### BEST MODE FOR CARRYING OUT THE INVENTION

### FIRST EMBODIMENT

A first invention according to the present application (hereinafter referred to also as “the present first invention”) will be described in accordance with a simple example. For example, to develop software for obtaining a sales amount, first a data item (word) “sales amount” which is an output data item to be obtained is prescribed as in the following equation. Next, new data items (“sales unit price” and “sales quantity”) appearing in the data generation equation are prescribed, respectively. This work is similarly continued until each data item is prescribed as input data, and completed when all the new data items turn to the input data:
(1) sales amount sales unit price×sales quantity;
(2) sales unit price=purchase unit price×(1+margin);
(3) sales quantity=input data;
(4) purchase unit price=input data;
(5) margin=input data.

Incidentally, in a correct process order, values of necessary data items have to be obtained before obtaining values of individual data items. Therefore, with regard to the correct process order, a person can find an order of (3), (4), (5), (these three are all input-data items, and therefore the process order for these three does not matter), (2), (1). Even in a complicated system in which there are many data items and there are also many condition branches, the person can find the correct order, if much time may be taken. However, unfortunately in the conventional software development method, a computer does not have a function of finding the process order. As described in the paragraphs of “Background Art”, problems of the conventional software development result from this computer's incapability of finding the process order.

Principle of the present first invention will be generally described as follows.

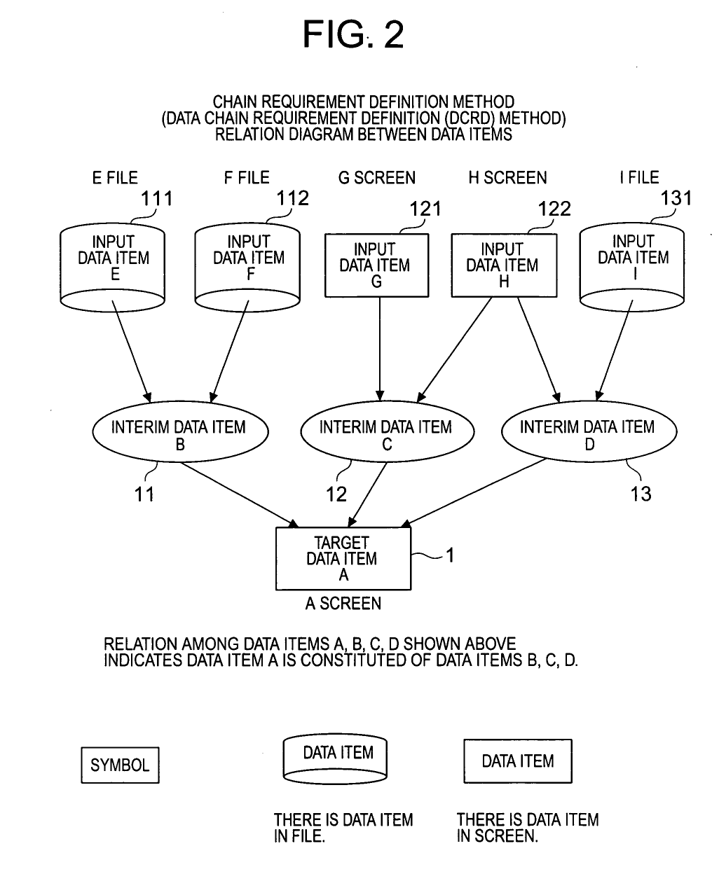

Whenever software is developed, a certain data item to be obtained necessarily exists. In a requirement definition method according to the present first invention, in general, first this target data item is determined, next the data item is prescribed, and subsequently new data items newly developed in a data generation equation or data generation equation execution conditions for the target data are further prescribed. This operation is sequentially performed in a chain manner. This is completed, when prescriptions of new data items finally constitute only input data items. The prescriptions of the data items are performed by prescriptions of the data generation equation, data generation equation execution conditions, attribute definition of an input/output, and a recording medium in which the data item exists. FIG. 2 (Data chain requirement definition method) shows an example of a relation between the data items.

That is, FIG. 2 is a schematic diagram schematically shows the relation between the data items, and also schematically showing a requirement definition method (referred to also as “data chain requirement definition” (DCRD) method) by chain data item prescription. It should be noted that this figure shows the relation between the data items, and is totally different from a data flowchart showing an order of data processing.

In the example shown in the figure, a target data item A (1 in the figure) is prescribed by an interim data item B (11 in the figure), an interim data item C (12 in the figure), and an interim data item D (13 in the figure). It is further shown that the interim data item B (11 in the figure) is prescribed by an input data item E stored in an E file 111, and an input data item F stored in a F file 112. Similarly, the interim data item C (12 in the figure) is prescribed by an input data item G existing on a G screen 121, and an input data item H existing on an H screen 122. On the other hand, the interim data item D (13 in the figure) is prescribed by an input data item H existing on the H screen 122, and an input data item I stored in an I file 131. This relation between the data items usually changes in accordance with various different types of software to be developed, functions, computer constitutions and the like. In fact, the E file 111, F file 112, I file 131, G screen 121, and H screen 122 are optional, and the input data items may be mounted on other mediums than shown here.

In a situation of FIG. 2 described above, here concretely, it is assumed that there are the following condition branches in the relation between the data items. That is,
if F>G, A=BxC/D,
otherwise A=C+G+H.

Incidentally, the above is written in a general program language in a conventional method as follows:
if F>G then A=BxC/D
else A=C+G+H.

In a case where there are the relation between the data items and the above-described condition branches as shown in FIG. 2, the requirement definition method (DCRD method) by the chain data item prescription is as follows. That is,
A=BxC/D (prescription of the data generation equation);
   F>G (prescription of the data generation equation execution condition); F [symbol]
   output data (prescription of the attribute definition of the input/output); output [symbol]
   existing in A screen (prescription of the recording medium in which the item exists). existing

[symbol]

(Here new data items are B, C, D, F, G, and therefore prescribed as follows. The prescribing is subsequently performed every time a new data item appears.)
A=C+G+H
   F<=G
   output data
   existing in A screen
B E+F
C=G/H
D=H−I
E=input data, existing in E file.
F=input data, existing in F file.
G=input data, existing in G screen.
H=input data, existing in H screen.
I=input data, existing in I file.

In an actual operation, for example, when the prescription is described with respect to each newly appearing word if a word prescription preparation table for requirement definition as shown in the following table 1 is used, a desired result can be achieved without any omission.

TABLE 1
Word prescription preparation table for data chain requirement definition

| | | | | | | | | | |
|---|---|---|---|---|---|---|---|---|---|
| Data | Data | Data | | | | | Recording | Recording | |
| item | item | item | Generation | Establishing | | | medium | medium | |
| number | name | ID | equation | condition | I | O | name | ID | Remarks |

Table 1 is a data item preparation table for requirement definition by chain data item prescription (data chain requirement definition) which is one of data item preparation tables, and this will be described later.

As described above, according to the present first invention, in production of software, by a method in which for requirement definition first a target data item is determined, and next new data items newly appearing in the data generation equation or the data generation equation execution condition are further prescribed, a human being does not have to consider a process order of data items or the like, and the items are sequentially extracted in a chain manner as if they were dug out. In other words, the present first invention provides a method in which in software development the requirement is defined only by the prescription of the data item, and the data items are easily and automatically extracted in a chain manner.

A software tool for defining the requirement by the data item in this manner is prepared. A targeted output data item name, identification code (ID), data generation equation (data item in the equation is written by name), data generation equation execution condition, attribute definition of input (I)/output (O), and name and ID of a recording medium where the data item exists are input in the respective column of the data items of Table 1 appearing on the screen. Then, the name and number of the data item newly appearing in the data generation equation or the data generation equation execution condition automatically appear in a new line. The data items newly appearing one after another in the new lines are prescribed one by one, so that the column may be automatically filled in. The requirement definition ends, when the newly appearing data items finally constitute input data.

As to the requirement definition completed by the prescription of the data item in this manner, the arrangement order of the data items has nothing to do with the process order of the data items. The process order of the data items has heretofore been instructed by the person via the program through the order in which the data items are arranged, or condition branches processing, or repetition processing and the like. Even in the chain automatic requirement definition by the data items performed in the present first invention, if according to the program of the conventional method, the human beings have to thereafter analyze/search the process order of the data items, and instruct the order by the program.

To solve the problem, in a second invention according to the present application (hereinafter referred to also as “the present second invention”), while a person does not instruct a process order of data items by a program, by commbining requirement definition automatically performed by the present first invention with a “automatic development method of the program” (e.g., method prescribed by the aforementioned “Lyee (registered trademark)”) which has capability of automatically determining the process order of the data items, development of software which is a final product is eventually automatically performed.

That is, according to the present second invention, the present first invention is used as a basis, and the automatic program development method, for example, Lyee (registered trademark), for automatically finding the process order of the data items or automatically establishing the data in a correct order is used based on the automatically obtained requirement definition. Therefore, a dramatic effect is brought that desired software development is totally automated to the last moment. Since the present first invention is described above in detail, and the Lyee (registered trademark) invention is described in detail in the aforementioned document, they are only pointed out here, and repeated description is omitted.

In summary, according to the present first invention, when producing software, first the target data item is determined, next the new data item newly appearing in the data generation equation or the data generation equation execution condition is further prescribed, accordingly human being does not have to consider any process order of the data items or the like, and it is possible to automatically and easily extract the data item and define the requirement in the chain manner.

Further, according to the present second invention, the automatic requirement definition performed by the present first invention, and the method (e.g., the aforementioned method prescribed by “Lyee (registered trademark)”) for automatically finding the process order of the data items based on the prescribed data items or automatically establishing the data in the correct order to automatically develop the program are used. Therefore, the software can be automatically developed.

### SECOND EMBODIMENT

Next, data chain requirement definition and requirement change tool will be described as a third invention of the present application.

In a case where a requirement word is actually newly prescribed by data chain requirement definition method, or a requirement word is to be changed in accordance with a change of requirement, computer software which is a tool for execution may be used.

Basic principle of the tool software is remarkably simple. Here it is again confirmed that the change of the requirement is a “change of definition of the requirement word, that is, prescription of each requirement word”, and its change/deletion/addition. Needless to say, the basic principle of the tool software is the same as that of the present invention as follows:
(a) screen display (format is Table 1) of the definition before the change of the requirement word to be changed, and a change operation with respect to the display;
(b) screen display of definitions of a first link defining word group and a first link containing word group before and after the change of the word to be changed (these (a) and (b) are the aforementioned Y-operation);
(c) study by a person on whether or not the prescription change is required with respect to each word of the above (b);
(d) as a result of the above (c), an operation similar to the above (a), (b), (c) with respect to the word which needs to be changed;
(e) The change operation of the corresponding requirement word is completed, when the prescriptions of all words derived from the certain requirement word do not have to be changed any more as a result of the above (d).

In a case where the change is the new addition of the requirement word, the newly defining indicates a change from a state in which there is not any prescription to a state in which there is a prescription. Therefore, the change operation (a) may be performed as a new definition operation, and next (b), (c), (d), (e) may be performed accordingly.

In a case where the requirement word is defined in order to define the requirement completely newly, the requirement word to be changed does not exist yet. To perform the definition, the above-described change operation (a) may be performed from nothing as the new definition operation, and next the definition of the first link defining word group may be accordingly performed by (b), (c), (d), (e) as the new definition operation.

As described above, the tool software is the same one for the change as that for the new development. By nature even in the new development, in actuality, the requirement definition is not all determined from the beginning, and each requirement definition is performed while repeating the change by trial and error, and the whole requirement definition is eventually constructed. Therefore, an interim change cannot be avoided essentially. From this viewpoint, the tool for the new development should be the same as that for the change. And if frequent changes are very easily performed, it is desirable for the software development. The tool software of the data chain requirement definition method, having such capability, remarkably raises production efficiency as a software development method.

Many effects and advantages of the present invention are apparent from this detailed description of this application. The effects and advantages which have been described above will be summarized as follows.

As described above in the paragraphs of “Background Art”, the program needs to be constantly changed. Even in the already completed program, since the requirement constantly changes in accordance with changes of business environment or management policy, the program needs to be accordingly constantly changed.

Even in the newly developed program, since there is rather few cases in which all business or program systems are determined from the beginning, the program has to be completed through many changes in a programming process.

Meanwhile, as described above in the paragraphs of “Background Art”, calculation is executed following the order of imperative sentences of the program in the conventional method. Therefore, the person instructs and has to instruct the process order by an order in which the imperative sentences are written, or by writing destinations of conditioned branches. Then, since the process order is determined as above, the value of one data item in one program is determined by the preprocessing before the value is processed, and the corresponding processing concerned. Therefore, the value of one data item depends on a place where the item is written in one program. Therefore, as far as the preprocessing is understood, one data item may have another data generation equation or another value in one program. That is, it is not assured that one data item has the equal value regardless of the preprocessing which has been performed in one program. In the result, while the process order has to be determined by the person, instead a degree of freedom is generated in the definition or value of the data item. Therefore, the place and definition of one data item used in one program are not known by a person other than a person who prepares the program. Even the preparer does not remember the place or the definition long.

When the program is changed in accordance with the requirement change in this situation, the influence of the change of one program in another portion of the program is considered, and the portion has to be correctly changed if necessary. Therefore, in the conventional method, since the degree of freedom is made in the definition or the value of the data item as described above, the program can be arbitrarily prepared by the person without any rule, and therefore the place of the necessary change in the whole program is not known. It is not easy to find all necessary changes and correctly change the portions. This is because when one place is changed, the influence of the change on the whole program is not automatically known. To correctly change all, the person has to track all the imperative sentences in the program in detail, and extract and change the program to be changed.

On the other hand, the data chain requirement definition method of the present invention solves all the above-described problems of the conventional method both in the definition of the requirement and the change of the requirement.

Furthermore, if the requirement word group defined by this data chain requirement definition method is applied to the automatic programming method (e.g., Lyee (registered trademark). See Patent Documents 1 to 6) in which the process order does not matter, whether the software development is new development or requirement change, what the person has to consider is minimized and automated from the beginning of a definition process of the requirement till the programming, and a dramatic effect can be obtained.

In the present invention, since a large number of modifications and revisions can be easily performed for a person who has usual knowledge in the corresponding technical field, it is not preferable to limit the present invention to the very same constitutions or operations as those shown and described in this description. Therefore, all appropriate modified and equivalent articles may be regarded as included in the scope of the present invention. As described above in detail by the description and illustration of the concrete embodiment for carrying out the present invention, a large number of modifications, replacements, and changes are possible without departing from not only claims of the present patent application but also the range of the present invention defined in all described matters for the present invention.

Moreover, the invention according to the present application is not limited to detailed interpretation and combination of elements described above or shown in the drawings, when used. In the present invention, another embodiment is possible, and the present invention can be practically used and carried out by various methods. The phrases and terms used herein are for a purpose of description, and must not be regarded as functioning in a limiting manner.

Therefore, any person who has usual knowledge in the corresponding technical field should understand that the basic concept of the present description can be easily utilized as a basis for designing another structure, method, and system for carrying out several objects of the present invention. Therefore, it is considered that equivalent interpretations are included in the claims of the present application unless departing from the concept and the scope of the present invention.

Moreover, though so far the automatic development method of the computer software has been mainly described above, needless to say, the technical thoughts according to the present invention can be realized and utilized for, for example, an automatic development apparatus of computer software, an automatic development programs, and a recording medium/transfer medium/paper medium in which the automatic development program is recorded, or even for the category such as a computer/apparatus on which the automatic development program is mounted, and a client server type for executing the automatic development program.

Furthermore, the present invention is suitable even for mounting in not only a single processor, single hard disk drive, and computer system comprising a single local memory but also, as a option of the system, a plurality of any or combined processors or storage devices The computer system include an elaborate calculator, hand type computer, laptop/notebook computer, mini computer, main frame computer, and super computer, and a processing system network combination of them. The system may be replaced with any appropriate processing system that functions according to the principle of the present invention, or a combination with this system may be used.

Moreover, the technical thoughts according to the present invention are by nature applicable to any type of programming language. Furthermore, the technical thoughts according to the present invention are also applicable even to any type/function of application software.

Furthermore, as to the present second invention, an object to be combined with the present first invention may be any method of automatically developing the program with the automatic requirement definition obtained by the present first invention, and the object is not limited to the above-described “Lyee (registered trademark)”.

Additionally, the present invention permits various modifications, additions, replacements, enlargements, reductions and the like within a range of the same and equivalent technical thoughts. Even when the software produced using the present invention is mounted as a commodity on a secondary product, the value of the present invention is not reduced.

As described above, according to the requirement definition method of the present invention, it is possible to automatically and easily extract the data items, and define the requirement in a chain manner.

Moreover, in the automatic development method of the computer software of the present invention, a portion other than a portion that has to be necessarily instructed by human beings is eliminated from a development process of the computer software, in the result the software is developed as automatically as possible so that automation can be realized.

Furthermore, according to the data chain requirement definition method of the present invention, the problem of the conventional method, “the place of a portion required to be changed by the influence of the change of one program in the whole program is not known”, is all solved both in the new definition of the requirement or the change of the requirement.

Additionally, the requirement word group defined by this data chain requirement definition method is applied to the automatic programming method (e.g., Lyee (registered trademark)) in which the process order does not matter. Then, whether the software development is new development or requirement change, what the person has to consider is minimized and automated from the beginning of definition process of the requirement till the programming, and a dramatic effect can be obtained.

### INDUSTRIAL APPLICABILITY

In the present invention, it becomes possible to extract data items and define requirements automatically and easily in a chain manner. A portion other than a portion that has to be necessarily instructed by human beings is removed from a development process of computer software, in the result the software is developed as automatically as possible so that automation can be realized. Accordingly, great effects such as large efficiency enhancement of software production, productivity enhancement, and quality enhancement are brought in a software industry.

1. A requirement definition method comprising:
(a) a step of extracting all output data items to be finally obtained by computer software which is a development object;
(b) a step of prescribing one of the extracted output data items by a data generation equation and a data generation equation execution condition;
(c) a step of prescribing all new data items by separate data generation equations and data generation equation execution conditions with respect to all the new data items that have appeared in order to prescribe the data generation equation and the data generation equation execution condition in said (b);
(d) a step of repeating the step (c) until the data generation equation is constituted only of an input data item; and
(e) a step of executing the steps (a) to (d) with respect to all the output data items to be finally obtained, and constituting requirement definition by the data generation equation and the data generation equation execution condition obtained as a result of such execution.

2. The requirement definition method according to claim 1, wherein the data items in the step (b) or (c) are also prescribed by an attribute definition of an input/output and explicit indication of a recording medium in which the data item exists in addition to the data generation equation and the data generation equation execution condition, and
wherein further prescription relating to the attribute definition of the input/output and indication of the recording medium in which the data item exists is also regarded as the requirement definition in addition to the data generation equation and the data generation equation execution condition in the step (e).

3. A method of automatically developing computer software, comprising:
(a) a step of obtaining requirement definition using the requirement definition method according to claim 1 or 2; and
(b) a step of applying such definition to a method of automatically finding a process order of data items or automatically establishing data in a correct order to automatically develop a program based on data items prescribed in the obtained requirement definition in the (a), thus obtaining desired software as a result of the application.

4. A method of changing a requirement word in changing requirement of a program automatically prepared by application of such following information to a method capable of automatically programming irrelevant to an order of arrangement of prescribed requirement words as requirement words (=data items) group prescribed as the requirement of software, the information being prescribed by:
a name of the word;
a data generation equation (including: obtaining a value by an input) to obtain a value corresponding to the word;
a condition (data generation equation execution condition) on which the value corresponding to the word is established;
an attribute definition indicating whether the word is an input or an output; and
a recording medium in which the word exists,
wherein the method of changing the requirement word comprises:
(a) an operation of changing (changing including deleting and adding) prescription of the requirement word itself to be changed;
(b) an operation of extracting first link defining words and first link containing words before and after the change of the requirement word concerned as requirement words having a possibility that prescription change is required by an influence of the change of the prescription of the word of the above (a);
(c) an operation of studying whether or not the change of the prescription is required with respect to the individual extracted words; and
(d) an operation of repeating the operations of the (a) to (c) with respect to the word requiring the change.

5. A method of newly prescribing a requirement word in new development of a program automatically prepared by application of such information to a method capable of automatically programming irrelevant to an order of arrangement of prescribed requirement words as requirement words (=data items) group prescribed as the requirement of software, the information being prescribed by:
a name of the word;
a data generation equation (including: obtaining a value by an input) to obtain a value corresponding to the word;
a condition (data generation equation execution condition) on which the value corresponding to the word is is established;
an attribute definition indicating whether the word is an input or an output; and
a recording medium in which the word exists,
wherein the method of newly prescribing the requirement word, in light of consideration that the new development requires both a new requirement prescription operation and its correction operation, new requirement prescription is therefore regarded as a change from nothing in the new development of the program, comprises:
(a) an operation of changing (changing including deleting and adding) prescription of the requirement word itself to be changed;
(b) an operation of extracting first link defining words and first link containing words before and after the change of the requirement word concerned as requirement words having a possibility that prescription change is required by an influence of the change of the prescription of the word of said (a);
(c) an operation of studying whether or not the change of the prescription is required with respect to the individual extracted words; and
(d) an operation of repeating the operations of said (a) to (c) with respect to the word requiring the change.
